(19) United States
(12) Patent Application Publication
(10) Pub. No.: US 2008/0253243 A1
(43) Pub. Date: Oct. 16, 2008

(54) Controlling an Optical Disc Drive

(75) Inventor: Stefan Geusens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,763

(22) PCT Filed: Aug. 28, 2006
(86) PCT No.: PCT/IB06/52975

§ 371 Date: Mar. 5, 2008

(30) Foreign Application Priority Data
Sep. 6, 2005 (EP) 05108132.1

(51) Int. Cl. G11B 5/09

(52) U.S. Cl. 369/47.1

(57) ABSTRACT

The invention provides an optical disc drive and a method for controlling a moving part, e.g. a disc tray or an optical pick-up unit, of such an optical disc drive. The method comprises, upon a start-up command being received, reading a reliability register, e.g. one bit, indicating whether stored data relating to the position of the moving part are reliable. In case the reliability register indicates that that stored data relating to the position of the moving part are un-reliable, then a blind homing is performed, and data relating to the position of the moving part are then stored in a memory. Preferably, a controlled homing action is performed after receipt of a stop command. An optical disc drive according the invention comprises a moving part (MP), a motor (MTR), e.g. a stepping motor, for driving the moving part (MP), a memory (MEM) for storing data relating to the position of the moving part (MP), a reliability register (REL_reg) for storing whether the data relating to the position of the moving part (MP) are reliable, and adjusting means (ADJ) for reading the memory (MEM) and adjusting settings of the motor (MTR), e.g. motor angle, according to the data read from the memory (MEM) in case the reliability register (REL_reg) indicates that data are reliable. The reliability register enables the best possible utilization of the stored position relevant data for adjusting settings of the motor driving the moving part of the optical disc drive. According to a preferred algorithm with proper use of the reliability register, blind homing actions can be minimized or completely eliminated during normal use of the optical disc drive, and still the disc drive will be able to function properly.

The invention relates to the field of controlling optical disc drives. More specifically, the invention describes a method for controlling homing actions related to moving parts of an optical disc drive, and an optical disc drive with improved homing performance.

An optical drive may comprise several stepping motor controlled moving parts, such as an optical pick-up unit (OPU), a collimator in the optical path of the OPU, radial and/or tangential tilt mechanisms, as well as disc tray, etc. To determine the position of the moving part, a homing procedure is required. Once the position is known, it is possible to perform a movement and to keep the position under control.

To detect the homing position in a robust manner a sensor is needed. This homing sensor can be a mechanical switch or an electrical measurement (e.g. back-EMF or current measurement). It is difficult to manufacture and/or tune such a sensor for a number of reasons. A mechanical switch has a considerable position tolerance, an electrical measurement can be (too) late to detect a mechanical stopper. To control a stepping motor a sine and cosine signal must be provided to the coils of the stepping motor. This sine and cosine signal must be in phase with the magnetic angle of the stepping motor. However, after power up this angle is not known.

As a consequence of the above difficulties the homing can have large tolerances so that extra calibrations are needed after start-up. Furthermore, a “blind homing” without any control of the actual position of the moving part may include the moving part hitting a mechanical stopper which may limit the working life of the optical disc drive.

U.S. Pat. No. 4,706,008 discloses an optical disc drive with a memory for storing a phase state of the motor driving the moving part of the optical disc drive, and a flip-flop is used to detect if a start-up is a “cold start”. Only after a “cold start” a blind homing will be performed, and thus the number of blind homing actions may be reduced. However, e.g. if the moving part is moved by an external force (e.g. in case of a shock), then the optical disc drive will still rely on the stored phase state being in accordance with the position of the moving part, while the actual position of the moving part has changed. Thus, a power off-power on (causing a blind homing) will be needed to restore the optical disc drive for proper operation in such a situation.

US 2004/0013053 discloses an optical disc drive with a moving part where a position memory is updated for each movement of the moving part performed by the driving motor. Still, the same problem exists as described for the optical disc drive of U.S. Pat. No. 4,706,008, namely that the optical disc drive will loose control of the actual position of the moving part, if the moving part is moved by an external force (e.g. in case of a shock).

Following the above, it may be seen as an object of the present invention to provide a method of controlling a moving part of an optical disc drive where the number of blind homing actions are reduced and still with a control that ensures proper operation under normal use.

This invention describes a method of storing the position of a moving part so that the position is still known after power down.

A first aspect of the invention provides a method for controlling a moving part of an optical disc drive, the method comprising the steps of

1) reading in a reliability register whether stored data relating to the position of the moving part are reliable, upon a start-up command being received,
2) in case the reliability register indicates that the stored data relating to the position of the moving part are un-reliable:
performing a blind homing,
storing data relating to the position of the moving part, and
   3) in case the reliability register indicates that the stored data relating to the position of the moving part are reliable:
storing in the reliability register that the stored data relating to the position of the moving part are un-reliable.

By introducing the step of reading a reliability register, e.g. a one bit register or memory, which is used to indicate whether stored data relating to the position of the moving part are reliable or un-reliable, it is possible to significantly reduce the number of blind homing actions and still preserve proper operation. Performing a blind homing is only necessary in case this reliability register indicates that stored position data are un-reliable and therefore invalid to use. Thus, during normal use of the optical disc drive, a blind homing is not necessary; controlled homing actions can be used instead of blind homing actions. This saves time, and it can be ensured that the moving part avoids hitting a mechanical stop.

After having performed the blind homing in step 2) and subsequent updating the position data, the reliability register is set to “un-reliable”. This is advantageous since in case of any failure, meaning a failure which can result in unreliable sledge position, e.g. a shock causing an unintended movement of the moving part, the reliability register will indicate in such situation that the stored position data are un-reliable and therefore a blind homing is required.

In preferred embodiments blind homing will only be performed in special situations. For example a blind homing is necessary in case of power failure during normal operation. In such a situation the next start-up will be followed by a blind homing action. Another example is when a disc is found to be present but the disc can not for some reason be recognized, i.e. start-up failed. In such situation it is not 100% sure that the position of the moving part is still reliable, and therefore it is preferred that the subsequent start-up is followed by a blind homing.

In a preferred embodiment of the method of the first aspect, the method further comprises the steps of

4) in case the reliability register indicates that the stored data relating to the position of the moving part are reliable:
reading stored data relating to the position of the moving part, and
adjusting settings of a motor driving the moving part according to the read data relating to the position of the moving part.

According to this embodiment the reliability register indicates that the stored position data are valid, and therefore these position data can be read and used to adjust setting of the motor driving the moving part in accordance therewith.

In another preferred embodiment, the method further comprises the step of

5) performing a controlled homing upon a stop command being received.

A controlled homing, i.e. performing a controlled movement of the moving part to a predefined position using knowledge of its actual position, is advantageous to perform after a stop command has been received. Hereby time for a homing action is saved upon receipt of the next start command, and thus the optical disc drive is capable of responding faster to a start command in normal operation.

It is an additional advantage that writing to a non-volatile memory (which is needed because a uncontrolled power off should also handled correctly) may be limited to a minimum: only during start-up (reliability register) and stop (position and reliability register). Thereby it is possible to use presently known non-volatile memory of optical drives like EEPROM, etc., because the number that a writing acting is allowed to such a non-volatile memory is limited and with the present invention the use of e.g. the EEPROM stays well within the specification. Typically, an EEPROM may have a specified upper limit of 5000 times of writing actions.

Preferably, the mentioned controlled homing action further comprises the steps of

6) detecting if any error occurred prior to or during the controlled homing,
7) in case no error was detected during the controlled homing:
storing data relating to the position of the moving part, and
storing in the reliability register that the stored data relating to the position of the moving part are reliable.

According to this embodiment the controlled homing is verified and in case no errors occurred during movement of the moving part to the predefined homing position, data relating to the position of the moving part is updated and the reliability register is set to “reliable” thus indicating that at a subsequent start-up it is possible to utilize the stored position data instead of performing a blind homing. When using non-volatile memory the information (angle, reliability) is still available after a power off. There is no difference in the drive reaction between cold or warm start-up.

In preferred embodiments, the data relating to the position of the moving part comprise data relevant to adjusting the settings of a motor driving the moving part. Thus, in case e.g. of a stepping motor the relevant data may comprise a value indicating a magnetic angle of the stepping motor.

It is to be understood that even though the various steps described are numbered, it is within the scope of the first aspect to change order of these steps.

With preferred algorithms according to the method will reduce blind homing actions of a moving part an event that will occur such as an average of once every 100 start-ups. This will result in improved working life of the moving part. A homing can be very stressful for the system and a blind homing will only be performed rarely. In addition, the method will help reduce wear because a lot of movements are not necessary. The method improves start-up position tolerances, which result in better disc reconditioning performance.

Calibrations, needed because of the large tolerances of a blind homing, can be skipped. It may be possibility to completely omit a homing detector, the detector being e.g. a mechanical or an electrical detector. Omitting a homing detector will increase the homing tolerances and the mechanical wear. However, with an algorithm according to the invention, the latter is acceptable because the blind homing of a moving part can be seen as a kind of a recovery, which seldom occurs. Start-up time will be shorter because time consuming blind homing actions are eliminated in connection with most start-up actions.

In a second aspect, the invention provides an optical disc drive comprising
a moving part,
a motor for driving the moving part,
non-volatile memory for storing data relating to the position of the moving part,
a reliability register for storing whether the data relating to the position of the moving part are reliable,
adjusting means for reading the memory and adjusting settings of the motor according to the data read from the memory in case the reliability register indicates that data are reliable.

An optical disc drive according to the second aspect is capable of utilizing the advantages described above in connection with the first aspect. The reliability register and the memory may be implemented using a non-volatile type of memory such as a flash memory and/or an Electrically Erasable Programmable Read Only Memory (EEPROM) which will always be present in connection with an optical disc drive. The reliability register only needs to be one bit (e.g. 0 indicating “un-reliable” and 1 indicating “reliable”), and appropriate data relating to a position of the moving part may be stored using such as only 8 bit or another relevant number of bits to represent e.g. a magnetic angle of the motor. In a first embodiment, the memory uses 1 bit for the reliability bit and 7 bits to represent the magnetic angle of the motor. So one byte may be enough to contain the information. Of course the 7 bits to represent the magnetic angle of the motor can be more or less, such as 2, 3, 4, 5, 6, 8, 9, 10, 11, 12, 13, 14, 15, and 16, depending on the desired accuracy. Thus, with only a small amount of memory space required, existing memory in an optical disc drive, or in connection with an optical disc drive, may be utilized. The adjusting means may be implemented as a part of an existing routine, i.e. software, for controlling an optical disc drive.

In preferred embodiments, the moving part can be one or more of: an optical pick-up unit, a collimator in an optical path of an optical pick-up unit, a radial tilt mechanism, a tangential tile mechanism, a disc tray.

In a preferred embodiment the motor driving the moving part comprises a stepping motor, and the memory is capable of storing a value representing a magnetic angle of the stepping motor. In other embodiments, the motor may comprise a e.g. a tacho controlled brush(less) DC motor and store the position of the moving part of the DC/AC motor and just store the reliability of the position when stopped.

In a third aspect, the invention provides an electronic chip for an optical disc drive, the electronic chip comprising
a non-volatile memory for storing data relating to the position of a moving part of the optical disc drive,
a reliability register comprising at least one bit for storing whether data relating to the position of the moving part are reliable,
a controller adapted to read the reliability register whether data stored in the memory are reliable, upon a start-up command being received, and in case the reliability register indicates that the stored data are un-reliable, the controller is adapted to:
   initiate a blind homing of the moving part of the optical disc drive,
   store in the memory data relating to the position of the moving part, and
in case the reliability register indicates that the stored data are reliable, the controller is adapted to:
   store in the reliability register that the stored data relating to the position of the moving part are un-reliable.

It is to be understood that the electronic chip may be implemented as one single chip or alternatively, the features may be spread to two or more chips, i.e. a chip set for an optical disc drive. The one or more chips with the features according to the third aspect may be integrated into chips that provide other functionalities related to the optical disc drive and optionally other devices.

With respect to advantages, the same advantages apply as described in connection with the first aspect. It is to be understood that the variants described with respect to the first and second aspects also apply for the third aspects.

In a fourth aspect, the invention provides a device comprising an optical disc drive, the optical disc drive comprising
a moving part,
a motor for driving the moving part,
a non-volatile memory for storing data relating to the position of the moving part,
a register for storing whether the data relating to the position of the moving part are reliable,
adjusting means for reading data relating to the position of the moving part from the memory and adjusting settings of the motor in accordance herewith.

The device may be such as player and/or recorders for CDs, DVDs, BD, HD-DVD and equivalents and variant thereof together with magnetic storage devices. Thus, the device may be an audio device, a video device, combined audio/video devices or data storage devices. A non-exhaustive list of device examples are: CD players, SACD players, DVD players/recorders, BD players/recorders, HD-DVD players/recorders, hard disc recorders, TV sets with built in optical storage means, CD ROM or DVD recorders for computers.

The same explanations of functions and advantages as described above for the first and second aspects apply.

In a fifth aspect, the invention provides a computer readable program code for use in combination with an optical disc drive having a moving part, the computer readable program code being adapted to

1) reading in a reliability register whether stored data relating to the position of the moving part are reliable, upon a start-up command being received,
2) in case the reliability register indicates that the stored data relating to the position of the moving part are un-reliable:
initiate a blind homing,
store data relating to the position of the moving part, and
   3) in case the reliability register indicates that the stored data relating to the position of the moving part are reliable:
store in the reliability register that the stored data relating to the position of the moving part are un-reliable.

The computer readable program code may be implemented together with existing code adapted to control the function of an optical disc drive. The program code may be present on a storage medium or stored in a RAM or ROM memory. The same advantages apply as set forth in connection with the first aspect.

In the following the invention is described in more details with reference to the accompanying figures, of which

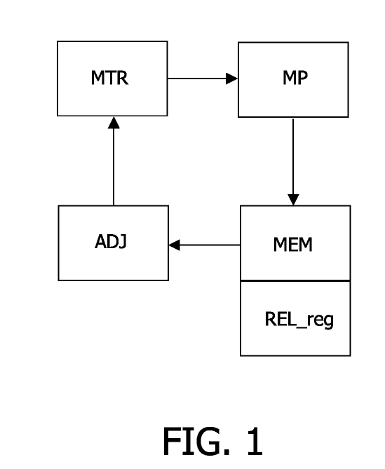

FIG. 1 illustrates a block diagram of an optical disc drive embodiment according to the invention, and

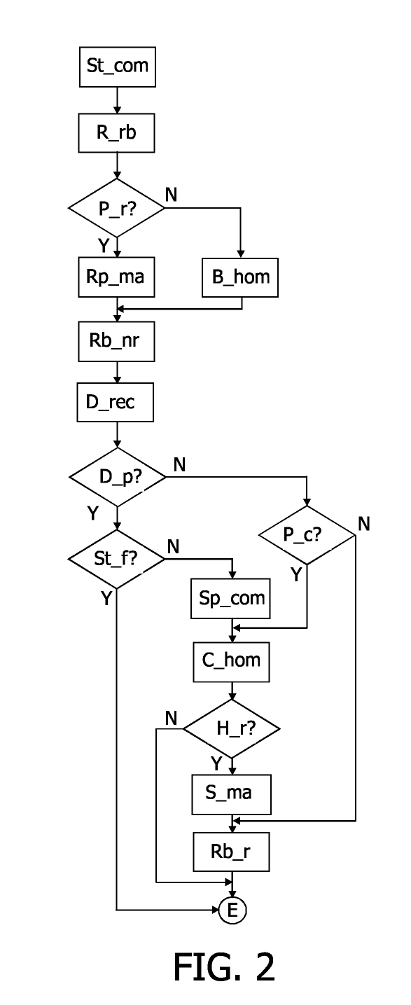

FIG. 2 illustrates a flow chart showing a preferred algorithm for control of homing in an optical disc drive.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

FIG. 1 shows vital part of a preferred embodiment of an optical disc drive according to the invention. A motor MTR is connected to drive a moving part MP of the optical disc drive. E.g. the motor MTR may be a stepping motor and the moving part MP may be a disc tray that is mounted to perform a linear motion. An actual position of the moving part MP is crucial with respect to adjust electrical signals to the motor MTR. Thus, a memory MEM, preferably a non-volatile type memory, is used to store data relating to the position of the moving part MP once a reliable position of the moving art MP has been obtained. It should be mentioned that the writing actions to a non-volatile memory must be limited. The data relating to the position of the moving part MP may comprise such as a displacement in mm from a fixed homing position or more advantageously, the data may comprise data that are directly relevant with respect to control of the motor MTR, e.g. a magnetic angle in case of a stepping motor. This will allow adjusting means ADJ, e.g. a microprocessor circuit, to read the memory MEM and adjust settings of the motor MTR according to the data read from the memory MEM. If e.g. a displacement from a fixed homing position of the moving part MP is stored, then the adjusting means ADJ will need to calculate or translate this displacement into a value relevant with respect to adjusting settings for controlling the motor MTR in accordance thereto.

Since normally the motor MTR is directly mechanically connected with the moving part MP, there will be a direct connection between a position of the moving part MP and e.g. a magnetic angle of the motor MTR in case it is a stepping motor. However, knowing only for instance a magnetic angle of a stepping motor, additional data relating to the position of the moving part MP is required in order to be able to bring the moving part MP to a desired position, since the same magnetic angle of the motor MTR may correspond to several positions of the moving part MP. Thus, e.g. moving the sledge to a 26 mm radius during the controlled homing C_hom it is only needed to have this information hard coded available in the firmware of the drive. Only the angle information is needed in the non-volatile memory.

In order to be able to utilize the data relating to the position of the moving part MP stored in memory MEM for all possible operating conditions, a reliability register REL_reg is associated with the memory MEM. This register REL_reg is preferably one bit indicating if the data in memory MEM are reliable or un-reliable. Prior to reading data from the memory MEM for updating motor settings, the adjusting means ADJ checks the reliability register REL_reg. If the register REL_reg indicates that data are reliable, then the adjusting means ADJ can read data from the memory MEM and motor settings can be updated in accordance therewith. If the register REL_reg indicates that data are, for some reason, un-reliable, then the adjusting means ADJ may initiate a blind homing action so as to regain track of position of the moving part MP and subsequently store position data in memory MEM once a successful blind homing actions has been performed.

It is to be understood that the adjusting means ADJ, the memory MEM and the reliability register REL_reg may be an integral part of the optical disc drive or implemented entirely or partially using a separate chip set comprising one or more separate electronic chips.

FIG. 2 shows a flow chart of a preferred algorithm for control of an optical disc drive according to the invention. The algorithm will be explained in the following assuming an optical disc drive with the elements as described in connection with FIG. 1. The algorithm is an example where a moving part of the optical disc drive is driven by a stepping motor.

Upon receipt of a start-up command St_com, the first step R_rb is to read a reliability bit. This answers the questions P_r? if position of the moving part is reliable or not. In case of yes Y, the next step Rp_ma of reading the motor angle from memory. This information will be used to preset the phase of the sine and cosine signal needed to control the stepping motor. In case the answer to question P_r? is no N, then a blind homing B_hom is performed instead. This will be the case e.g. with a fatal error caused by a large external shock or caused by an unwanted power shut down. After the blind homing B_hom or alternatively after the step Rp_ma as described, the next step Rb_nr is to set the reliability bit to “un-reliable”, i.e. not reliable. Thus, it is ensured that the reliability bit is set to “un-reliable” after a blind homing B_hom or alternatively an Rp_ma step is performed. This will allow position changes of the moving part when needed. Subsequently, the next step D_rec is a disc recognizing procedure, which will not be described in further detail since it is not important with respect to the invention. Next step D_p? is to check whether a disc is present. If yes Y, then it is checked St_f? whether start-up has failed. If start-up St_f? has failed Y, then the algorithm ends E. If start-up St_f? does not fail N, then the algorithm proceeds as if a stop command Sp_com was received.

If disc is found D_p? not to be present N, then it is checked P_c? whether position of the moving part has changed. If the position has not changed N, then the algorithm ends E after the step Rb_r of setting the reliability bit to “reliable”. If position P_c? has changes Y, then the next step is to proceed as after a stop command Sp_com has been received.

This is done in order to limit the number of blind homing as very often there is no disc in the drive. The wanted reaction of the drive is then as follows: When the reliability bit indicates that the position is not reliable a blind homing is performed and the drive detects that there is no disc available. Normally, the position is not changed and the reliability bit will be written to 1 (reliable). A second start-up (reliability bit indicates that the position is reliable) will be done without a homing. In conclusion, even if the start-up will fail because there is no disc (this occur very frequently) no extra blind homing is needed.

In a preferred embodiment, the step P_c? is omitted because when there is no disc available the sledge position should always be in control. This is because the action Rp_ma or B_hom will lead to that C_Hom can be done (often 0 displacement of course) and H_r? is therefore always yes Y.

Upon receipt of a stop command Sp_com (or shut down command), the following step is to perform a controlled homing C_hom, i.e. a controlled movement of the moving part to its homing position. After this is performed, it is checked H_r? whether the achieved home position can be considered as reliable, i.e. no fatal error occurred before the stop command, such as external shocks or errors during the controlled homing, etc. If not N, then the algorithm ends E. If the home position is considered reliable Y, then next step S_ma is to store the current motor angle in memory and the reliability bit is set to “reliable” Rb_r.

Upon receipt of a start-up command St_com after a stop command Sp_com procedure has been performed as described, will thus result in that the blind homing B_hom being omitted, and instead the stored motor angle data S_ma resulting from the controlled homing C_hom will be used to adjust motor settings Rp_ma. Thus, a quick start-up and less wear on bearings and elements of the moving part is the result.

In case of a cold start, i.e. a start-up command St_com after a normal power off after the disc drive has finished its procedure after a stop command Sp_com, and a subsequent power on, then the reliability bit will still indicate that motor data relating to the current position stored in memory are still reliable, and therefore a Rp_ma action can be performed.

If power is turned off e.g. during a disc recognition procedure D_rec, then the reliability bit will indicate “un-reliable” as power is turned back on, and a start command St_com is received. This will cause a blind homing B_hom.

If power is turned off after a stop command Sp_com procedure has been properly finished, and the moving part is subsequently moved by an external force, e.g. due to a shock during transportation, a subsequent start-up command St_com will at first instance utilize the stored data Rp_ma, since the reliability bit will indicate that data are “reliable”, and the question P_r? will be answered by yes Y. The reliability bit will then be set to “un-reliable” Rb_nr. However, due to the changed position, the start-up will fail, the answer to the question St_f? will therefore be yes Y, and the algorithm will end. A subsequent start-up command St_com will result in a blind homing B_hom, since now the reliability bit will indicate “un-reliable”, and the answer to question P_r? will be no N.

The described algorithm will be easily implemented in software code such as a part of existing code for controlling an optical disc drive.

The algorithm has been described in details in connection with an application using a stepping motor. The algorithm or part of the algorithm can also be used for other kind of motors used in a closed or open loop type of control loop.

Reference signs in the claims merely serve to increase readability. These reference signs should not in any way be construed as limiting the scope of the claims.

1. A method for controlling a moving part of an optical disc drive, the method comprising the steps of
1) reading in a reliability register whether stored data relating to the position of the moving part are reliable, upon a start-up command being received,
2) in case the reliability register indicates that the stored data relating to the position of the moving part are un-reliable:
performing a blind homing,
storing data relating to the position of the moving part, and
3) in case the reliability register indicates that the stored data relating to the position of the moving part are reliable:
storing in the reliability register that the stored data relating to the position of the moving part are un-reliable.

2. Method according to claim 1, further comprising the steps of
4) in case the reliability register indicates that the stored data relating to the position of the moving part are reliable:
reading stored data relating to the position of the moving part, and
adjusting the settings of a motor driving the moving part according to the read data relating to the position of the moving part.

3. Method according to claim 1, further comprising the step of
5) performing a controlled homing upon a stop command being received.

4. Method according to claim 3, further comprising the steps of
6) detecting if any error occurred prior to or during the controlled homing,
7) in case no error was detected during the controlled homing:
storing data relating to the position of the moving part, and
storing in the reliability register that the stored data relating to the position of the moving part are reliable.

5. Method according to claim 1, wherein the data relating to the position of the moving part comprise data relevant to adjusting the settings of a motor driving the moving part.

6. An optical disc drive comprising
a moving part (MP),
a motor (MTR) for driving the moving part (MP),
a non-volatile memory (MEM) for storing data relating to the position of the moving part (MP),
a reliability register (REL_reg) for storing whether the data relating to the position of the moving part (MP) are reliable, and
adjusting means (ADJ) for reading the memory (MEM) and adjusting settings of the motor (MTR) according to the data read from the memory (MEM) in case the reliability register (REL_reg) indicates that data are reliable.

7. Optical disc drive according to claim 6, wherein the moving part (MP) is selected from the group consisting of: an optical pick-up unit, a collimator in an optical path of an optical pick-up unit, a radial tilt mechanism, a tangential tilt mechanism, a disc tray.

8. Optical disc drive according to claim 6, wherein the motor (MTR) comprises a stepping motor, and wherein the memory (MEM) is capable of storing a value representing a magnetic angle of the stepping motor.

9. An electronic chip for an optical disc drive, the electronic chip comprising
a non-volatile memory (MEM) for storing data relating to the position of a moving part (MP) of the optical disc drive,
a reliability register (REL_reg) comprising at least one bit for storing whether data relating to the position of the moving part are reliable, and
a controller adapted to reading in the reliability register whether data stored in the memory (MEM) are reliable, upon a start-up command being received, and in case the reliability register (REL_reg) indicates that the stored data are un-reliable, the controller is adapted to:
initiating a blind homing of the moving part (MP) of the optical disc drive,
storing in the memory data relating to the position of the moving part (MP), and
in case the reliability register (REL_reg) indicates that the stored data are reliable, the controller is adapted to:
storing in the reliability register (REL_reg) that the stored data relating to the position of the moving part (MP) are un-reliable.

10. A device comprising an optical disc drive, the optical disc drive comprising
a moving part (MP),
a motor (MTR) for driving the moving part (MP),
a non-volatile memory (MEM) for storing data relating to the position of the moving part (MP),
a reliability register (REL_reg) for storing whether the data relating to the position of the moving part (MP) are reliable, and
adjusting means (ADJ) for reading data relating to the position of the moving part (MP) from the memory (MEM) and adjusting settings of the motor (MTR) in accordance herewith.

11. A computer readable program code for use in combination with an optical disc drive having a moving part, the computer readable program code being adapted to
1) reading in a reliability register whether stored data relating to the position of the moving part are reliable, upon a start-up command being received,
2) in case the reliability register indicates that the stored data relating to the position of the moving part are un-reliable:
initiating a blind homing,
storing data relating to the position of the moving part, and
3) in case the reliability register indicates that the stored data relating to the position of the moving part are reliable:
storing in the reliability register that the stored data relating to the position of the moving part are un-reliable.
